(19) United States
(12) Patent Application Publication
(10) Pub. No.: US 2015/0050454 A1
(43) Pub. Date: Feb. 19, 2015

(54) MULTILAYER FLEXIBLE ELEMENT, PREFERABLY MADE OF WOOD, AND RELATED PRODUCTION PROCESS BY LASER ENGRAVING AND/OR CUTTING

(71) Applicants: Marcello Antonelli, Rome (IT); Marta Antonelli, Rome (IT)

(72) Inventors: Marcello Antonelli, Rome (IT); Marta Antonelli, Rome (IT)

(73) Assignee: MYMANTRA S.R.L., Rome (IT)

(21) Appl. No.: 14/357,207

(22) PCT Filed: Feb. 7, 2012
(86) PCT No.: PCT/IT2012/000042

§ 371 Date: Sep. 22, 2014

(30) Foreign Application Priority Data
Nov. 9, 2011 (IT) RM2011A000592

(51) Int. Cl. B27K 5/00; B32B 21/04; B32B 38/00

(52) U.S. Cl. CPC B27K 5/005; B32B 38/0008; B32B 21/04; B32B 2250/03; B32B 2317/16; B32B 2437/00; B32B 2479/00
USPC 428/141; 264/400; 156/272.8

(57) ABSTRACT

Multilayer flexible element (10), preferably made of wood, and related production process (50) by laser engraving and/or cutting, preferably applied in fashion, furniture and design industries, characterized in that said element is composed of:—a layer of rigid material (11), supplied in sheets or plates, preferably made of wood;—a layer of flexible support material (12), in example a tissue, onto which is connected said layer of rigid material (11);—means of connection (13) of said layer of rigid material (11) to said layer of flexible support material (12), in example by glue, characterized by high elasticity and resistance to temperature changes;—a texture in vector graphics (14) which will define the cutting of the workpiece material, his flexibility and the consequent modeling and softness; wherein said process (50) comprises the following steps:—connection (51) of said layer of rigid material (11) to said layer of flexible support material (12), in example by glue;—design (52) of said texture in vector graphics (14), and download into a control system of an industrial device suitable to generate and focus a high power laser beam;—engraving (53) and/or cutting of said layer of rigid material (11), guided by the above- mentioned texture (14), by fusion and high temperature evaporation caused by a laser beam; in order to make flexible some rigid materials, like in example wood and similar materials, and suitable as decorative and/or functional elements for covering in fashion, furniture and design industries.

The present invention relates a multilayer flexible element, preferably made of wood, and related production process by laser engraving and/or cutting. More exactly, the production process consists in the processing of materials, in which a material previously rigid after the processing acquires characteristics and properties typical of a tissue, in such a way to be suitable as raw material, preferably in clothing, furnishing and design. The production process is based on the use of a laser device able to realize a pattern of grooves on the top layer of a multilayer material that, after the processing, can be used in the same way of a flexible material.

In the state of the art procedures have already been developed to make products made of wood or other rigid material appropriately worked to create a flexible structure that can adapt to various shapes and profiles, so that the above-mentioned products can be used as clothing accessories or furnishing. In some cases, these structures are real clothes. The technique used up to now consists in realizing a basic structure articulated, for example a metallic structure with some pins that allow the rotation of a part on the other, within this metallic structure are inserted wooden dowels to form a mosaic. The procedure provides for the cut of the single dowels, and the subsequent manual installation, one at a time, up to form the final product. This processing determines a problem of precision, for the fact that intervenes an operator to realize the product, and there is also a problem of timing, because the processing must follow a manual operation. There is also a problem of costs because to realize a single product you employ a certain quantity of raw material, a certain time to design the product and manufacture it manually, and also you need labor which must intervene directly.

All the above disadvantages are overcome by the present invention which has as main objective to make usable the same way of a tissue or other flexible material, those materials (preferably wood, but also laminates, aluminum, etc.) which by their nature and characteristics have a rigid structure and limited modeling.

A further objective is that such materials, adequately processed, can be used in the applications already in use both for tissues that for the leather.

Another objective is to use these materials (wood, laminates, plexiglas, aluminum, copper, etc.) in order to enrich the range of materials already usable in clothing and design, particularly in textiles and tanneries.

A further objective is that the mode of processing ensures high speed and precision. Another objective is that this processing technique is extremely versatile in such a way you can operate in different sectors, from clothing to furnishings, up to the automotive industry.

A further objective is that this processing is without direct contact with the material, so as to provide the maximum safety for the operator.

Another objective is that the laser engraving and/or cutting should be permanent, unalterable and unchangeable.

Therefore, it is specific subject of the present invention a multilayer flexible element, preferably made of wood, and related production process by laser engraving and/or cutting, preferably applied in fashion, furniture and design industries, characterized in that said element is composed of:
a layer of rigid material, supplied in sheets or plates, preferably made of wood;
a layer of flexible support material, in example a tissue, onto which is connected said layer of rigid material;
means of connection of said layer of rigid material to said layer of flexible support material, in example by glue, characterized by high elasticity and resistance to temperature changes;
a texture in vector graphics which will define the cutting of the workpiece material, his flexibility and the consequent modeling and softness; wherein said process comprises the following steps:
connection of said layer of rigid material to said layer of flexible support material, in example by glue;
design of said texture in vector graphics, and download into a control system of an industrial device suitable to generate and focus a high power laser beam;
engraving and/or cutting of said layer of rigid material, guided by the above-mentioned texture, by fusion and high temperature evaporation caused by a laser beam;
   in order to make flexible some rigid materials, like in example wood and similar materials, and suitable as decorative and/or functional elements for covering in fashion, furniture and design industries.

The present invention will now be described for illustrative but not limitative, with particular reference to the figures of the accompanying drawings, in which:

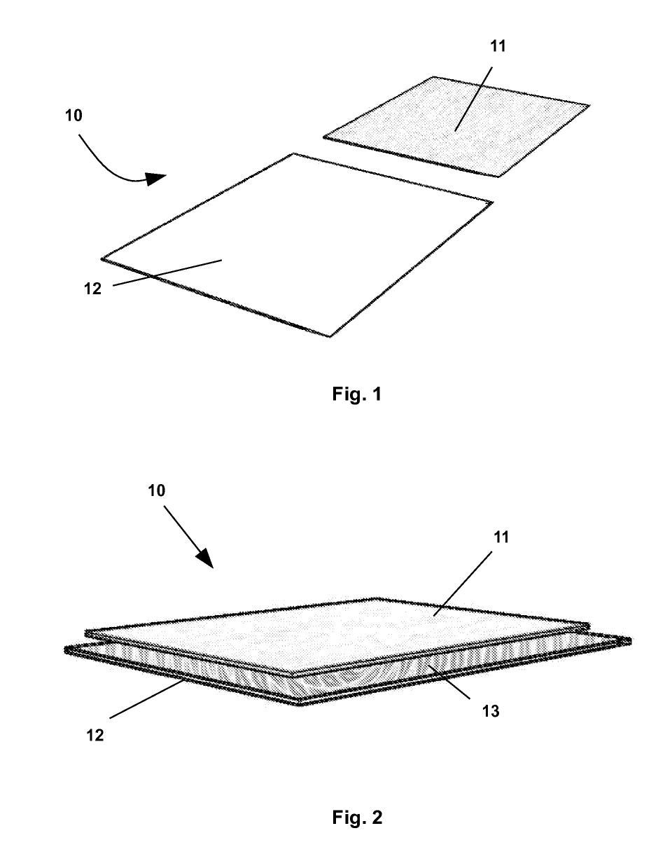

FIG. 1 is a perspective view of the rigid material and of the flexible support, provided in elements already cut that will go subsequently glued between them;

FIG. 2 is a perspective view of the gluing phase of the above mentioned materials means a layer of glue or adhesive;

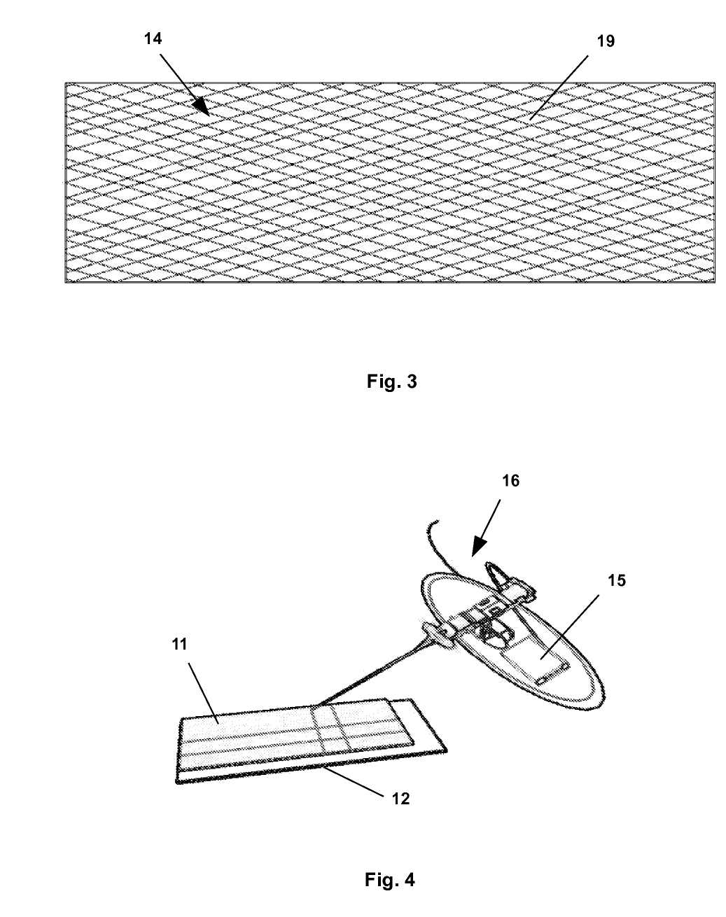

FIG. 3 is a front view of a texture that defines the cutting of the rigid material;

FIG. 4 is a perspective view of a laser device, which provides the processing of the multilayer material;

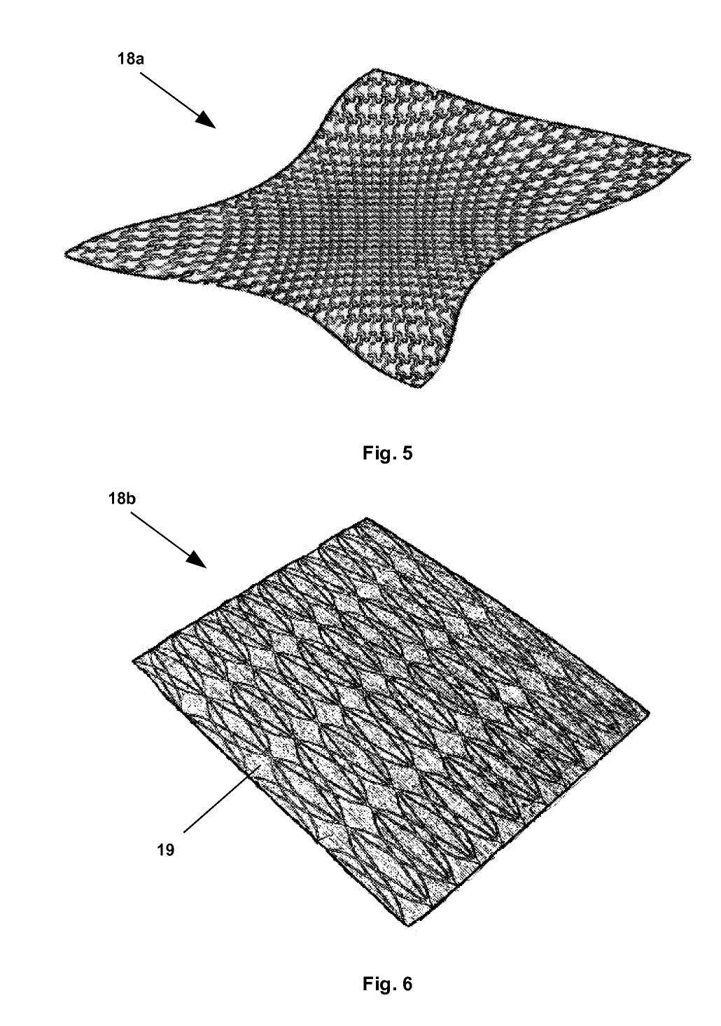

FIG. 5 is a perspective view of a first example of flexible material, which is the final result of such procedure of processing;

FIG. 6 is a perspective view of a second example of flexible material, which is the final result of such procedure of processing;

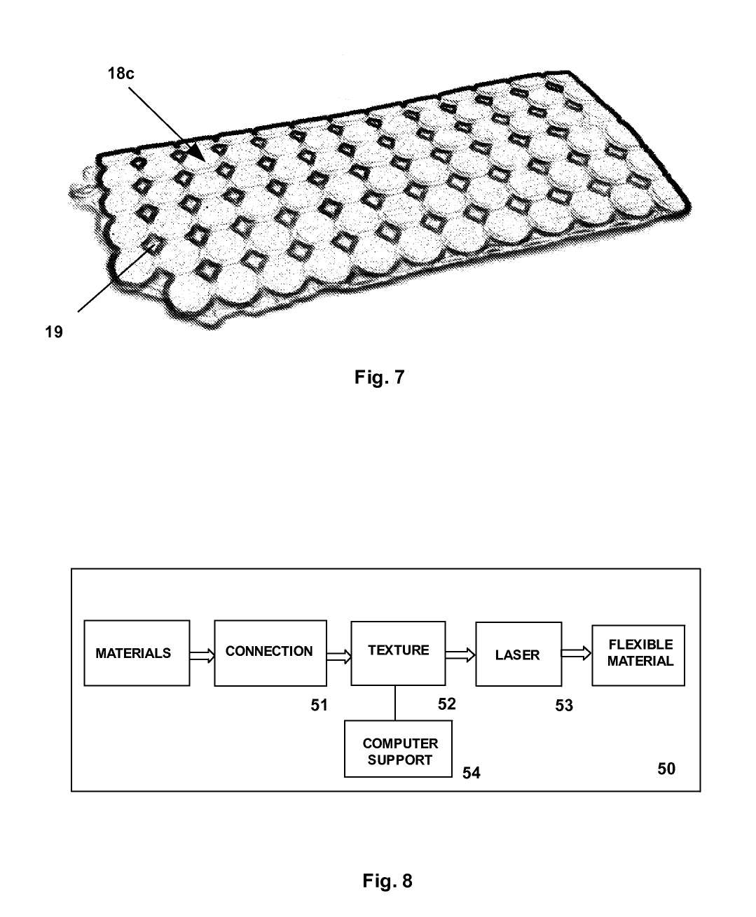

FIG. 7 is a perspective view of a third example of flexible material, which is the final result of such procedure of processing;

FIG. 8 is a functional block diagram of the various phases of the procedure for the realization of the new material.

Below will be described for illustrative but not limitative purposes only one of the possible embodiments of the present invention being possible to describe other embodiments on the basis of the particular technical solutions identified. In the various figures the same elements will be indicated with the same identification numbers. The first thing to occupy to make this manufacturing process is the retrieval of materials, that are illustrated in FIG. 1. The rigid material 11 will have to be necessarily procured in sheets, coils or plates already cut; the thickness of each sheet may vary from 1/10 mm to 10 mm, depending of its intended use and of the flexible support 12 to which must be appropriately glued. The size of the rigid material 11 should also be capable of being accommodated in a laser engraving and cutting machine. The flexible support 12 can be made of tissue, on net support, e.g. glass fiber or fiber of flax, which guarantee high softness and flexibility, the flexible support 12 will have to be the same size of the rigid material 11 to which subsequently will be glued and must have a uniform surface in such a way to allow an adequate gluing. In particular, in FIG. 1 is illustrated the rigid material 11, in particular such rigid material 11 is wood, which through the manufacturing would be made usable as a tissue. Wood was chosen because it has very good properties such as lightness, insulating (acoustic and electromagnetic), it is an ecological material, biocompatible (natural raw material, renewable, recyclable and it can be obtained with low energy cost) and it is also aesthetically pleasing. These properties make this material widely used in various sectors. Once you have retrieved the materials, you pass to the phase of final gluing of rigid material 11 with the flexible support 12, in such a way to form a multilayer element 10, as is illustrated in FIG. 2. For the bonding is preferable to use an adhesive 13 that maintains adequate elasticity, water resistance and temperature changes resistance after drying and that is able to merge the two layers of material definitively. Depending on the materials to be processed you can use vinyl glue, hot glue, contact adhesives, or adhesives sealants. After that you will provide to the realization of a texture 14 in vector graphics (e.g. that illustrated in FIG. 3), which will be reproduced on the layer of rigid material 11 through the laser device 16 which will provide to engrave and/or cut the said layer, as illustrated in FIG. 4. In particular the laser cuts the materials through vaporization, merger or through combustion and every material reacts in a different way, because of differences of hardness, chemical composition, surface finish, reflective capacity and obviously thickness. The engraving process refers to the possibility of marking the surface with a micro fusion, a combustion or a removal of material. The difference depends on the chemical composition and on the reaction to the heat of the various materials. The above mentioned texture 14, generated to the computer with graphics programs or through specific software, can be stored in a data storage device 15, the texture 14 will guide the laser device 16 during the engraving and/or the cutting of the single layer of rigid material 11, previously glued on the flexible support 12; this assumes that the laser device 16 must be calibrated so that power, velocity and degree of definition affect only the thickness of the rigid material 11, leaving unchanged the layer of adhesive 13 and the underlying flexible support 12. The fact that the texture 14 is into vector graphics allows to express the data in a format that takes up less space than the equivalent raster; and also guarantees the possibility of enlargement, without encountering a loss of resolution, such is a fundamental requirement to obtain maximum precision during the processing. The type of texture 14 (its structure, size, spacing between lines, etc.) will define the degree of armor and the consequent modeling and softness of the treated material, as well as direction of the fiber and the direction of the fold. The texture 14 will give essentially the ornamental aspect of the engraved surface, defining the degree of flexibility and softness of the multilayer material 10. The pieces 19 of the texture 14 can, depending on the requirement and the effect that you'll want to produce, have size ranging from 1 mm² up to 10 mm² or eventually even more. With reference to FIG. 5, the new material 18a, as a result of reproduction by the laser of the texture 14 on the multilayer material 10, in particular on the layer of rigid material 11, will not be rigid but fractionated in hundreds/thousands of pieces 19 as defined in the succession of lines that make up the texture 14. In FIG. 6 is illustrated a further type of new material 18b obtainable through the same technique of processing. In FIG. 7 is illustrated a variant of the new material 18c in which it is expected the possibility of eliminating some pieces 19 of the texture 14 according to which is divided the layer of rigid material 11, in such a way as to increase the flexibility and allow the folding of the above mentioned new material 18c in more directions; it becomes therefore fundamental the choice of the type of texture 14 to be reproduced on the layer of rigid material 11, the texture 14 defines not only the appearance purely aesthetic of the new material 18a-18b-18c but also its functionality and consequently its possible applications. The new material 18a-18b-18c, obtained by the above mentioned manufacturing through laser engraving and/or cutting of the multilayer material 10, according to a pattern of grooves defined by the texture 14, will be called for convenience “soft material” and may find application in the compartments of clothing, furniture and design. FIG. 8 shows schematically the steps in blocks of the entire manufacturing process 50 through laser device able to realize new materials: the laser device 53 through engraving and/or cutting reproduces on the top layer of the multilayer material 10 the texture 52, stored in a data storage device 54, thus creating a new material 18a-18b-18c not more rigid, called for convenience soft material. Once the new material 18a-18b-18c is ready for use, it may be subject to further process of gluing and/or sewing in such a way to be suitable in tailoring to create clothes, tents, accessories, etc. Otherwise the new material 18a-18b-18c can be treated with hardeners resins, in such a way to make it rigid and applicable for example in furniture or vehicle industries.

The above examples demonstrate, therefore, that the present invention achieves all the goals proposed. In particular it allows to make usable the same way of a tissue or other flexible material, those materials (preferably wood, but also laminates, aluminum, etc.) which by their nature and characteristics have a rigid structure and limited modeling.

Furthermore such materials, adequately processed, can be used in the applications already in use both for tissues that for the leather.

In addition you can use these materials (wood, laminates, plexiglas, aluminum, copper, etc.) in order to enrich the range of materials already usable in clothing and design, particularly in textiles and tanneries.

Furthermore the mode of processing ensures high speed and precision.

In addition this processing technique is extremely versatile in such a way you can operate in different sectors, from clothing to furnishing, up to the automotive industry.

Furthermore this processing is without direct contact with the material, so as to provide the maximum safety for the operator.

In addition the laser engraving and/or cutting should be permanent, unalterable and unchangeable.

The present invention has been described by way of illustration but not limitation, according to a preferred embodiment, it is intended that any changes and/or modifications may be made by experts without leaving out of the scope of protection, as defined by the appended claims.

1-10. (canceled)

11. A process for producing a multilayer flexible element by laser engraving and/or cutting, said multilayer flexible element comprising: a layer of rigid material, preferably made of wood, having a structure of slots on its surface; a layer of flexible support material, in example a tissue, onto which said layer of rigid material is connected; means of connection of said layer of rigid material to said layer of flexible support material, in example by glue, said process comprising the following steps:
connection by overlaying said layer of rigid material on said layer of flexible support material, in example by glue;
design of a texture in vector graphics defining a structure of lines, and download it into a control system of an industrial device able to generate and focus a high power laser beam, called laser device;
engraving and/or cutting of said layer of rigid material, according to the above-mentioned texture, by fusion and high temperature evaporation caused by a laser beam, in order to create said structure of slots on said layer of rigid material, so that said multilayer flexible element represents a new material that is composed of a layer
of rigid material, in example wood or similar rigid materials, being flexible so that it can be used as a decorative and/or functional element for covering in fashion, furniture and design industries.

12. The process of claim 11 for producing said multilayer flexible element, said process including the following additional step:
the new material is submitted to a further process of gluing and/or sewing in parts of tissue,
in such a way to be suitable in tailoring to create clothes, tents, accessories, etc.

13. The process of claim 11 for producing said multilayer flexible element, said process including the following additional step:
the new material is treated with hardeners resins fixing its shapes,
in such a way to make it rigid and applicable for example in furniture or vehicle industries.

14. A multilayer flexible element produced according to the process in claim 11, the multilayer flexible element preferably applied in fashion, furniture and design industries, comprising: a layer of rigid material, preferably made of wood, having a structure of slots on its surface; a layer of flexible support material, in example a tissue, onto which said layer of rigid material is connected; and means of connection of said layer of rigid material to said layer of flexible support material, in example by glue.

15. The multilayer flexible element of claim 14, wherein:
the thickness of each sheet or plate of the above-mentioned layer of rigid material is between 1/10 mm and 10 mm, according to its intended use and the layer of flexible support which is properly glued;
the flexible support has the same size of the rigid material which will be glued; and
the flexible support has a uniform surface, in such a way to allow adequate gluing.

16. The multilayer flexible element of claim 14, wherein:
said glue, to be used to connect said layer of rigid material to said flexible support material, has chemical-physical characteristics suitable to maintain high elasticity, water resistance and temperature changes resistance after drying, in such a way to glue the two sheets of material definitely.

17. The multilayer flexible element of claim 14, wherein:
said texture, generated by a computer with programs for graphics, or using a specific software, can be stored in a data storage device, and represents the input of means guiding a laser device during the engraving and/or the cutting of the single layer of rigid material, previously glued on the flexible support,
so that said new material obtained by the above-mentioned process through laser engraving and/or cutting, will have no longer a rigid structure but will have its upper part divided in hundred pieces as defined in the structure of lines that make up the texture.

18. The multilayer flexible element of claim 14, wherein:
the laser device is calibrated so that power, velocity and degree of definition affect only the thickness of the rigid material, leaving unchanged the layer of adhesive and the underlying flexible support.

19. The multilayer flexible element of claim 14, wherein:
said pieces of the texture have size ranging from 1 mm² up to 10 mm², or eventually even more, according to application and visual effect that is required to be produced.

20. The multilayer flexible element of claim 14, wherein:
the above-mentioned pieces of the texture can be removed from said layer of rigid material,
in such a way to increase flexibility and allow the folding of the new material in many directions and consequently increase its possible applications.
